(19) United States
(12) Patent Application Publication
(10) Pub. No.: US 2020/0221696 A1
(43) Pub. Date: Jul. 16, 2020

(54) ACTIVE INGREDIENT ENHANCER FORMULATION FOR INSECTICIDE PAINT AND OBTAINED PAINT

(71) Applicant: Supernova Coatings SA DE CV, Cuajimalpa de Morelos (MX)

(72) Inventors: JOSE MARIA RIBOT BARROSO, Cuajimalpa de Morelos Cd. De Mexico (MX); BERNARDO AGUSTIN MENDOZA FLORES, Cuajimalpa de Morelos Cd. De Mexico (MX)

(73) Assignee: Supernova Coatings SA DE CV, Cuajimalpa de Morelos (MX)

(21) Appl. No.: 16/831,820

(22) Filed: Mar. 27, 2020

(30) Foreign Application Priority Data
May 24, 2018 (MX) MX/A/2019/006093

(51) Int. Cl. A01N 37/38; A01N 43/30

(52) U.S. Cl. CPC A01N 37/38; A01N 43/30

(57) ABSTRACT

This invention refers to an active ingredient enhancing formulation for insecticide paint, characterized by having, at least, one microencapsulated active ingredient (insecticide) selected from Cypermethrin, Deltamethrin or a mix thereof, including Piperonyl Butoxide (PBO) as catalyzing agent of such active ingredient (insecticide); where the microcapsule forming composition consists of mineral oil, Cypermethrin, or Deltamethrin or a mix thereof as an active ingredient (insecticide), Propylene Glycol, Piperonyl Butoxide, as a catalyzing agent for the active ingredient, Nonyl phenol 10, Melamine, Chitosan, Acetic acid, Glutaraldehyde, Sodium hydroxide and calcium chloride.

### FIELD OF INVENTION

This invention relates to chemistry in general, specifically, it relates to the field of water-based coatings formulation such as paint, enamel, inks, sealers, polyurethanes, among others. More specifically, it refers to an active ingredient (insecticides) enhancer formulation for insecticide paint that allows to repel reduce and control insects.

### INVENTION BACKGROUND

Insects are arthropods characterized by having a pair of antennas, three pairs of legs, and two pairs of wings (which can be removed or missing). Insects are the most diverse group in the planet, and there is a great diversity of species with around one million different species described, and these can be found in almost all environments.

Insects comprise one of the animal classes that, are more interrelated with human activities. From useful insects that provide us with honey or silk all the way to poisonous insects or that carry deathly diseases, there are endless species directly or indirectly related to human beings (Newman, L. H. 1971).

Insects play an essential role in environmental functions. They are the main predators of other invertebrates and; thus, they control plagues. They decompose and eliminate a significant percentage of organic matter, and they are the main plant pollinators of ecological and economic relevance. Nevertheless, and sometimes due to their high abundance, they are considered a harmful group, as they consume around one third of crops at a global level, and they are the main carriers of human diseases (Brusca and Brusca, 2002).

Insects have coexisted with human beings forever, and they are a part of the ecological balance of the planet, as they represent food for birds, reptiles and even other insects. On the other hand, many of them carry diseases; such as dengue, the Chagas disease, zika, chikungunya, yellow fever, malaria among other diseases; thus, it is very important to control them.

There are several insect control methods, such as biological control, chemical control (insecticides, pesticides, acaricides, nematicides, systemic and non-systemic insecticides, organic controls, among others).

There are insecticide products in the market, such as aerosols, plastic plates and tapes, anti-insect paper and paint, with several effectiveness degrees Nevertheless, these products have a low residuality and a high cost, in addition to strong and toxic smells for humans, and some of them use pesticides as active ingredients, which can damage health. Most products that exist in the market do not comply with the duration and functionality stated on the label and, due to their high costs, they are limited to people or companies with a significant purchasing power, popular classes being at the highest risk of contagion due to insect bites.

Microencapsulation is a technique used more and more, and its applications give rise to a growing interest in several technology fields, reaching several lines of work, from agriculture to the food industry, cosmetics and pharmaceuticals, and the textile and aerospace industries.

Microcapsules release the material contained in them during the preparation of other products to enhance, or deliver a different appearance to, the products. For example, in perfumes; essential oils are microencapsulated to create a non-liquid formulation, it is solid and applied in much lower concentrations, being more manageable.

Microencapsulation consists of applying a thin layer on small solid particles liquid droplets or scatterings, in order to protect, separate, or better handle and store materials. It can also lead to the delivery of the coated substances under specific conditions, or in a deferred, extended manner.

These conditions required for delivery can be humidity, pH, physical forces or the combination thereof. Coated particles in the microcapsules have a size from one to 500 microns. Size can be controlled in the manufacturing process.

Microencapsulation is used in order to change some physical properties of liquids or solids, in order to protect them or make them more manageable. With this technique, oily solutions can turn into solid products, and it is possible to control the delivery and modify some colloidal and surface properties of the substances coated.

This also allows to mix and store substances that react or are incompatible to each other in the same container. This is also used to cover a bad taste or smell of substances, reducing the volatile characteristics of some substances.

After carrying out a search to determine the closest status of the technique, the following documents were found:

U.S. Pat. No. 6,280,759B1 by Ronald R. Price et al., dated Mar. 7, 1989 was found, which relates to microtubes that contain an active ingredient in their cavity, as well as compositions that contain such microtubes, which make them efficient to provide a slow and controlled release of the active ingredient. Such microtubes are useful for the production of coating compositions to protect surfaces that are in contact with water, adhesive resins for the manufacturing of laminated wood products, and devices to deliver pesticides. Such active ingredient is one or more members selected from the group that comprises fungicides, herbicides, insecticides, pheromones, hormones, antibiotics, anthelmintic agents and anti-fouling agents.

U.S. Pat. No. 6,881,248B2 by Han Lim Lee et al, dated Dec. 10, 2002 was also, found, which relates to a paint composition that can reduce the development of resistance to insecticides in insects. Such paint contains 25-mg to 50-mg of deltamethrin per liter used, as the main component, 12.5 to 1,350 mg of piperonyl butoxide per liter used, and emulsion paint as the third component.

U.S. Pat. No. 5,931,994A by Maria Pilar Mateo Herrero, dated Dec. 23, 1996, was also found, which relates to a paint composition to control plagues and allergens through a chitin synthesis inhibitor, which comprises a mix of 10 to 40% of weight in water, 5 to 50% of weight in resin 0.001 to 40% of weight in a chitin inhibitor, 0.001 to 5% of weight if organophosphate, 1 to 40% of weight in pigment, 1 to 60% of weight in a carrier material and 1 to 20% of weight in a stabilizer where percentages of weight are based on the total weight of the composition, where the chitin inhibitor is microencapsulated in a resin polymer.

U.S. Pat. No. 3,400,093A by Feinberg Irving, dated Mar. 11, 1996, was also found, which relates to a procedure to manufacture an insecticide polymer, which requires the dissolution of, at least, one organic insecticide in, at least, one vinyl-type polymerizable monomer, such monomer, and other vinyl-type monomers, with which polymerization is carried out, which provide the predominant monomeric units to the polymer, scattering such monomer in the form of droplets through an polymerization aqueous liquid medium, in which such monomer is substantially immiscible, and in which such insecticide is substantially insoluble, and polymerizing such monomer through polymerization techniques in emulsion, and the attainment of a stable polymer latex, which contains small discrete, usually polymer solid, particles incorporated into such insecticide.

Nevertheless, the products mentioned in the aforementioned documents have competitive disadvantages in comparison to our development, as our formulation consists of a dual effect in applications such as vinyl paint, this dual effect elevates the product's performance and effectiveness. Thanks to this high performance, the efficacy to repel, reduce and control flying, and crawling insects is even greater.

Patent application Mx/a/2016/017073 claims a powdered additive formulation for its incorporation in coatings or substrates to repel, reduce and control insects, which is characterized by containing at least one active insecticide ingredient, or a mix of two or more active insecticide ingredients (organochloride, organophosphates, carbamates, pyrethrin, biorational pesticides, plant extracts, among others) with a high-performance double microencapsulation (through a microencapsulation process, a microencapsulation process through coacervation or through a ionic gelation process) which provides/doses at least one insecticide in a certain period (months) and then provides/doses another insecticide in a different period and, alternatively, with at least one highly luminous microencapsulated reflective and/or photoluminescent pigment, which generates a dual insecticide, effect, quite effective during day and night.

Where the formulation comprises microsilica as a receptive capsule (carrier) to encapsulate the microcapsules of at least one insecticide component or a mix of two or more insecticide components and, at least, one highly luminescent microencapsulated reflective and/or photoluminescent pigment.

Nevertheless, the formulation of such invention shows low effectiveness. The formulation of this invention has been created in order to substantially enhance active ingredients/insecticides, maintaining a low content of these ingredients, but making them more effective, and this was attained when discovering that if one catalyzing/triggering element is added; acting in their composition, these active ingredients behaved in an enhanced manner, from 0.3 to times better than their initial form, this means that the PBO increases the effects of the very active ingredients by delaying internal detoxification systems of insects, which allows our paint to act for longer periods, offering a competitive advantage and an added value, that offers substantial results.

### INVENTION OBJECTIVES

The main objective of this invention is providing an active ingredient enhancer formulation for insecticide paint that allows an increase to the effectiveness of paint, offering better results to repel, reduce and control insects.

Another objective of the, invention is to provide an active ingredient enhancer formulation for insecticide paint, which also allows the increase of repellence and control power against insects, flies, spiders, scorpions, cockroaches which gradually doses the catalyzed active, ingredients for a long period, at least 3 years.

Another objective of the invention is providing an active ingredient enhancer formulation for insecticide paint that also offers low toxicity and does not affect human beings, domestic animals and/or farm animals.

Another objective of the invention of an active ingredient enhancer formulation for insecticide paint is to also provide a longer residual effect to repel, reduce and control flying and crawling insects, with a greater efficacy and for a much longer period.

Another objective of the invention is to provide an active ingredient enhancer formulation for insecticide paint, which also allows the control of insect populations by using common ways such as paint in homes, hospitals, schools, airports, farms, warehouses, industrial warehouses, constructions, hotels, public and private sectors, etc.

And all those objectives and advantages that will become evident by reading this description, along with the attached compositions, which are an essential part of this document.

### INVENTION DESCRIPTION

The active ingredient enhancer formulation for insecticide paint and obtained paint, according to the preferred modality of the invention, consists of at least one microencapsulated active ingredient (insecticide) that includes Piperonyl Butoxide (PBO) as microcapsule former in its formulation and a catalyzing agent of such active ingredient (insecticide) whose oxygen atoms interact with the molecules of at least one active ingredient (insecticide); boric acid as insecticide ingredient, calcium carbonate as powdered excipient and microsilica as binder “receptive capsule” (carrier).

Within the microcapsule forming formulation that encapsulates at least one active ingredient, Nonyl phenol 10 is also included to provide stability to the emulsion formed through stirring in a pre mixing process, which also allows the fluidity of the reaction.

In the preferred modality of the invention, such active ingredient (insecticide) is selected from Cypermethrin, Deltamethrin or a mix thereof.

In the preferred modality of the invention the active ingredient enhancer additive formulation for insecticide paint includes:

From 6.10-26.50 g and preferably 15 g of active ingredient (cypermethrin microcapsules, deltamethrin microcapsules and microcapsules, with cypermethrin and deltamethrin combined) to add to the finished paint:
From 2.0 to 5 g and, preferably, 4.27 g of Boric Acid
From 0.10 to 0.50 g and, preferably, 0.25 g of Deltamethrin
From 2.0 to 5.0 9 and, preferably 3.2 g of Cypermethrin
From 1.0 to 6.0 g and, preferably, 2 g of Calcium carbonate
From 2.0 to 10.0 g and preferably, 5.3 g of Microsilica

The paint is comprised by 2 parts, the paint as such and the active ingredient, the amounts proposed are used for the preparation of the microcapsule, and the following formulas, and their process, are used to prepare each one of them.

In the preferred modality of the invention, the microcapsule forming composition consists of:
Mineral oil
Cypermethrin or Deltamethrin or a mix thereof as active ingredient (insecticide)
Propylene glycol
Piperonyl butoxide as catalyzing agent for the active ingredient
Nonyl phenol 10
Melamine
Chitosan
Acetic acid
Glutaraldehyde
Sodium hydroxide
Calcium chloride

In the preferred modality of the invention, the active ingredient is microencapsulated in three microcapsules with the following composition.

### Material C (Cyper) Microcapsule

Mineral oil
Cypermethrin as active ingredient (insecticide)

### Propylene Glycol

Piperonyl butoxide as catalyzing agent for the active ingredient:
Nonyl phenol 10
Melamine
Chitosan
Acetic acid
Glutaraldehyde
Sodium hydroxide
Calcium chloride

### Material Δ(Delta) Microcapsule

Mineral oil
Deltamethrin as catalyzing agent for the active ingredient:
Propylene glycol
Piperonyl butoxide as catalyzing agent for the active ingredient:
Nonyl phenol 10
Melamine
Chitosan
Acetic acid
Glutaraldehyde
Sodium hydroxide
Calcium chloride

### Microcapsule Material C+Δ

Mineral oil
Deltamethrin as catalyzing agent for the active ingredient;
Cypermethrin as catalyzing agent for the active ingredient;
Propylene glycol
Piperonyl butoxide as catalyzing agent for the active ingredient;
Nonyl phenol 10
Melamine
Chitosan
Acetic acid
Glutaraldehyde
Sodium hydroxide
Calcium chloride

To complete the process, the microcapsules formed are applied, as d escribed before, plus the process additives to compensate the formula, such as boric acid, calcium carbonate, binder (microsilica used to join particles to each other), BTO insecticide trigger, used to activate the insecticide in the dose mentioned when the mix with the paint is done. The amount goes from 0.26 to 2%, and we use 0.20%.

The paint preparation process consists of the following stages:
a.—microcapsule preparation, with the previously described formulation;
b.—mixing the additives
c.—preparing the paint
the following is done for the preparation
a.—microcapsule scattering in additives. The following amounts are mixed, from 0.1-0.5 of delta microcapsules, from 2-5 cyper microcapsules and from 0.2-0.5 of delta+cyper microcapsules scattered in 1.30 of nonyl phenol, 1.5 of propylene glycol and 15 of slurry water, this is done with 400-rpm stirring for 30 min. This slurry is done in order to prevent lumps in the paint when microcapsules are added to the paint;
b.—adding the slurry (as active ingredient) to the paint with stirring for 5 hours at 60 rpm;
c.—extended stirring to scatter the microcapsule in the paint, which is done in three intervals. First, at 25 rpm only paint and slurry, halfway, microcapsules and water and, finally, only additives at 6 rpm, and with slurry at 80 rpm.

In another one of the preferred modalities of the invention, such active, ingredients (insecticides) are selected from a group that consists of organochloride, organophosphate, carbamate, pyrethrin, biorational pesticides, among other pesticides, and insecticides made from plant extracts.

The microencapsulation of at feast one active insecticide ingredient or the mix of two or more active insecticide ingredients is performed separately:

In the preferred modality of the invention, microencapsulation of at least one insecticide component or a mix of two or more insecticide components is done through a microencapsulation process, a microencapsulation process through coacervation or through a ionic gelation process.

Microencapsulation comprises a quite heterogeneous set of procedures, and it uses diverse techniques and materials. The following three stages are the most relevant:
Nucleus
Coating material
Characterization

In microencapsulation, the nucleus material comprises solid particles or small liquid drops and the integration thereof is done through stirring at high revolutions, using aids, stabilizers, antioxidants and diluents.

The coating materials used must be according to the final application product; for example, if the water steam action nucleus is to be protected or the coating must resist the extractive action of water, it must be hydrophobic, so it provides a proper protective barrier.

In characterization, it is attained for the nucleus material to be delivered under certain specific conditions that promote release, these conditions are separate from humidity and pH, and the mechanical pressure and force acting on them.

The microcapsules to be designed and proposed were prepared by considering the following:
a.—nucleation
B.—Shell hardness
c.—dispersibility
d.—pH

### Variables Identification

For the microcapsules release process, the following was considered:
1.—minimum percentage concentration
2.—concentration of active ingredient to release
3.—pH of medium
4.—type of paint to use
5.—application temperature
5.—environmental temperature
7.—roughness of the surface to paint
8.—insects to eliminate
9.—endemic insects
10.—invading insects
11.—plagues
12.—film thickness

### Microencapsulation Processes Used

1.—Polymeric Microencapsulation
2.—Microencapsulation through coacervation
3.—Ionic Microencapsulation

With the use of several Microencapsulation processes, several types of microcapsules with different characteristics are obtained, with different functions in relation to their release behavior.

### 1. Polymeric Microencapsulation

Microcapsules possess a relatively simple morphologic structure, they are comprised by two clearly identified elements, the active nucleus and a fine polymeric shell (coat) that surrounds the former. Due to the polymer characteristics, the gradual release of active ingredients is attained, inserted according to the specific application requirements of the substrate in which microcapsules are deposited.

The nucleus is comprised by liquid substances (mineral oil=, incorporating active insecticide ingredients.

The formation of the microcapsule is a complex physicochemical process, which results in a suspension of microcapsules that go from one to several hundreds of micrometers. Progressive and controlled release of microencapsulated active ingredients is attained thanks to the nature of the coating polymer allowing it.

In any case, wide-spectrum insecticide active ingredients, frequently used in many insecticide formulations are always used. In such a way, pyrethroids are used in case immediate control is required, as well as a shock effect without a great residuality. In case extended efficacy is required instead of a rather immediate effect, organophosphates are used. In all cases, paint incorporates a crawling/cockroach, flying insects and ants and flies repellent insecticide.

CHEMICAL DEVELOPMENT OF THE MICROCAPSULE. A polymer is a chemical substance comprised by macromolecules, usually organic ones, which were formed through the bond of repeated smaller molecules called monomers.

In such a way, obtaining a gradual-release, effective formulation will greatly depend on the ratios of these two monomers to form the resulting polymer, and also some other factors, inherent to the manufacturing process, such as the incorporation of insecticide active ingredients and the temperatures reached.

For all stages of the mean life of paint (manufacturing−liquid paint) (application−paint, liquid/dry) (permanence−paint/dry) with different types of polymer, the following is considered: First, the manufacturing stage in which the polymer is scattered in water, and along with the oils and resins, its shell hardness is low; when the paint is applied and drying starts, hardness increases. Secondly, for the polymers that have a hard shell, the microcapsule would be so rigid it would not allow an easy release of the active ingredient and, thirdly, in case of a soft polymer, release would be so fast, efficacy persistence would be too low. In the case of the polymer of this invention, the proper hardness, porosity and flexibility is obtained, attaining a high efficacy persistence due to the controlled release of active ingredients.

Other steps that are just as important are the addition of loads and pigments and the addition of insecticide active ingredients and stabilizers required for the formation of the microcapsule with the active ingredient protecting the active ingredients in an acid medium (pH 5-6) to maintain the chemical stability thereof overtime and; thus, all their insecticide properties.

A double shell can be given to an active ingredient, providing a longer life in its release; thus, controlling this characteristic overtime.

### EXAMPLE 1

### Powdered Insecticide Polymeric Microcapsules Components Per Lt

Mineral oil; 2.5 ml-5 ml or better 3.5 ml-8 ml
Cypermethrin or Deltamethrin or a mix thereof as active ingredient (insecticide)
Cypermethrin; 1.58 gr-4 gr or better 1 g-8 gr
Deltamethrin; 0.05 gr-2 gr or better 0.03 gr-3 gr
Propylene glycol; 0.18 ml-2 ml or better 15 ml-5 ml
Piperonyl butoxide as catalyzing agent for the active ingredient;
0.15 ml-0.20 ml of better 0.10 ml to 2 ml
Nonyl phenol 10; 0.20 ml-1 ml or better 0.15 ml-2 ml
Melamine; 0.15 gr-1.0 gr or netter 0.10-2 gr
Chitosan; 0.5 gr-2 gr or better 0.5 gr-4 gr
Acetic acid 0.05 ml
Glutaraldehyde 0.53 ml
Sodium hydroxide 0.026 ml
Calcium chloride solution at 5% 0.25 ml

### Methodology

1.—Weighting melamine and the active ingredient (insecticide with mineral oil) along with propylene glycol
2.—In a reactor, melamine, the active ingredient and propylene glycol are homogeneously incorporated for 30 minutes, Chitosan must be priorly scattered in a solution with acetic acid;
3.—Stir vigorously until a paste is formed, and add sodium hydroxide solution, Piperonyl butoxide, Nonyl phenol 10
And a glutaraldehyde portion;
4.—Stir for 30 minutes and add the remaining glutaraldehyde followed by calcium chloride;
5.—Stir the mix for 40 minutes and set it for filtration or, if necessary, decantation. Filter paper must be washed three times with distilled water, and the product obtained must be stored;
6.—Air dry, or centrifuge or heat dry at 25° C. in a stove for 5 h.
7.—For comfort, use the material scattered in the aqueous solution (slurry) or as wet powder.
8.—Packaging and storing in sealed containers, away from the light
   2. Microencapsulation through Coacervation

Within all microencapsulation methods, the attiring by complex coacervation method is appropriate for processing liquid active ingredients, as it uses a polysaccharide to form the shell as a reticulation matrix, followed by the addition of other agents, such as chelating agents, sequestering agents, colorings and preservatives that make the system so complex that must, be chemically divided to understand the release mechanism in the scattered system at issue and, on the other hand, it is considered that the formed shell must be hard and fragile at the same time to release the, encapsulated content, and the process must be reversible.

The coacervation process is a partial dehydration/dissolution of macromolecules that derives from two phases, one is rich in polymers and poor in solvent, called coacervate, and the other one is poor in polymers and rich in solvent, called floater.

Partial dehydration is performed under quite controlled conditions, in order to avoid the precipitation of the polymer and, in the process several phenomena can be observed, during stirring, there is a phase rich in colloids in scattering state, which looks like amorphous liquid droplets.

These droplets come together in a clear, homogenous liquid layer, rich in colloids, known as coacervate layer, which is deposited and produces the material for the wall of the resulting capsules; complex coacervation produces a simultaneous dissolution of 2 polymers, modifying pH, as ionic charges can neutralize each other; integrating a property to the rheology of the initial solution, either increasing or decreasing viscosity.

### EXAMPLE 2

### Liquid Ingredients Microcapsules Preparation Mode

### Process Description

1.—active ingredient emulsion
2.—matrix formation
3.—coacervate reticulation

First stage: the emulsion is created by adding the first materials, such as the active ingredient, with enough stirring to evenly integrate them, there is no increase in the solution viscosity, there is only scattering. The polymeric matrix forming agent is added, and stirring continues for a certain period, in order to form the proper globules that sequester the active ingredient. Then, a light viscosity is reached, which does not affect the established flow, the vortex is appropriate and there is enough shear strength.

Second stage: surfactant and pH modifying agents are added, as well as the rest of the matrix forming agent and the preservative. In case the microcapsule must be pigmented, coloring, previously scattered in water or oil, is added, and stirring continuous. A balance is reached at this point, which is observed through the increase or reduction of viscosity and a change in the emulsion color.

Third stage: the reticulating agent or hardener of the second layer formed are added, making sure stirring does not decrease. The emulsion declines, and viscosity is reduced, it may even disappear. Stirring continues at a much lower speed in, order not to destroy the microcapsules formed with a weak shell, and to prevent the reaction from going back to the emulsion stage. In this stage, the solution can be filtered or decanted to reintegrate the supernatant material that is not reacting to the solution core, or to obtain a solution with the right particle size for other uses required.

3. Ionin Gelation can also be done, Contemplating Certain Characteristics, such as:

### a.—Resistance to Alkalinity

Alkalinity is natural and common in almost all materials used for the construction of housing and; thus, the foundations where insecticide paint will be applied. This factor is decisive for the application of pesticides, as most active ingredients; particularly organophosphates and carbamates, are decomposed in alkaline mediums; requiring pH between 5 and 6 to stay relatively stable (Table A).

TABLE A
Mean life of some insecticide active ingredients in aqueous
mediums.

| Active | |
|---|---|
| ingredient | Decomposition time (Mean life) |
| Diflubenzuron | Stable in a pH range from 5 to 7. Hydrolyzed at pH 9. |
| Cypermethrin | pH 9 (7 days). Stable at pH 4. Quite stable in acid |
| | solutions. |
| Deltamethrin | pH 7 (8 hours) more stable in medium acid solutions |
| | than alkaline solutions |
| D-allethrin | Stable at pH 5 after 31 days. pH 7 (500 days) pH 9 |
| | (4.3 days) |
| Chlorpyrifos | At pH 10 (7 days). Stable in neutral and slightly acid |
| | solutions. |
| Diazinon | pH 9 (136 days). pH 7.5 (185 days). pH 5 (31 days). |
| Malathion | Quickly hydrolyzed at pH over 7. The optimal pH |
| | range is between 5 and 6. |
| Permethrin | Stable at pH between 5 and 6. |
| Pirimiphos- | pH 8 (5 days). pH 5 (7 days). |
| methyl | |
| Pyriproxifen | Stable in pH between 4 and 9. |

The active ingredient release mechanism from the microcapsule can be: release through the microcapsule porosity, through thermal expansion, fracture, by force or pressure and friction.

This alkaline hydrolysis causes a great reduction of actual efficacy of the formulation and, usually, it is directly proportional to the alkalinity of water or the medium the formulation touches.

The microcapsules of this invention maintain insecticide active ingredients at an acid pH; thus, providing a greater resistance to alkalinity that other conventional paints offer.

b. Adherence.

Usually, outdoor paint adheres to materials such as concrete, cement and the rest of mineral components usually found on a facade or a wall but, sometimes, there are other materials where the adherence of this type of paint is not satisfactory. Pain is highly adherent, and the microcapsules of this invention do not interfere at all with this characteristic.

c. Resistance to the Outdoors.

With this property, the capacity of the formulation to maintain its properties facing all kinds of external abiotic agents (humidity, sun rays, temperature, pressure) and even biotic agents, such as microorganisms, fungus and other live beings is measured.

In the case of paint, all paints deteriorate -at a greater or lower degree- when exposed to the outdoors. The most common effects are yellowing, cracking and also chalking (releasing surface powder). To measure the resistance to the outdoors paint is ex posed to “accelerated aging” subjecting the sample to UV radiation, greater than usual, and variable humidity and temperature conditions. See Bureau Veritas study

d. Resistance to Temperature.

This property is especially important for insecticides that possess active ingredients of the pyrethroid family, as these quickly degrade at high temperatures. Due to its very formulation, our additive with microcapsules counts on a greater resistance to temperature than conventional insecticides in an individual form.

e. Resistance to Wet Rubbing.

This property, supplementary to resistance to water, indicates the washability degree a coating count on. It is also a way to measure the paint resistance in case intense rain takes place.

In the preferred modality of the invention as receptive capsule (carrier) to encapsulate microcapsules of at least one insecticide component or a mix of two or more insecticides, microsilica is used.

In the preferred modality of the invention, the formulation includes calcium carbonate as powdered excipient.

Insecticide (active ingredients) mixes, types and amounts are managed by ranges, according to the specific insect and the delayed effect of their release.

### Formulation Example:

| | Amount in g | |
|---|---|---|
| Active ingredient | Minimum | Maximum |
| Microencapsulated | 0.10 | 0.50 |
| deltamethrin | | |
| Boric acid | 2 | 5 |
| Microencapsulated | 2 | 5 |
| cypermethrin | | |
| Calcium carbonate | 1 | 6 |

The invention provides a manufacturing process to formulate an active ingredient enhancer additive for insecticide paint for its incorporation into coatings or substrates to repel, reduce and control insects, which consists of:
a) Microencapsulating insecticide active ingredients through polymeric microencapsulation, coacervation or ionic gelation microencapsulation;
b) Incorporating microencapsulated insecticides and microsilica into a food grade stainless steel metallic recipient for 25 to 30 minutes at a maximum speed of 400 rpm, otherwise, the microcapsules could break. Also, only these three elements must be added first so the microsilica holes are filled with insecticide active ingredients, attaining extended duration of such active ingredients;
c) Incorporating the mix to boric acid, carefully, as the mix from the previous step is quite volatile and it may be toxic if inhaled. The use of safety gear is recommended at all times. Mix again at a speed of 400 rpm, for another 20 minutes, at least, to reach optimal results.
d) Add calcium carbonate, only to provide consistency to the formula. Nevertheless, calcium carbonate of the highest quality possible must be used, otherwise, it will not incorporate easily, even the color of the final product may be poor. The mix must be stirred at less than 400 rpm for 20 additional minutes.

In the modality where the active ingredient enhancer formulation for insecticide paint and its incorporation into coatings or substrates used to repel, reduce and control insects, 15 g of the formulation must be added per liter of water-based vinyl paint, as one of the paint ingredients.

The useful life of the paint can vary according to the manufacturer, in this case, it is recommended to use one with a quality of 5 years of useful life.

For manufacturing, special food-grade stainless steel equipment is required; a mixer with sealed doors to avoid the volatility of the mix, with a speed regulator as, if the speed is too high, the microcapsules may break and/or generate too much heat inside, leading the microcapsule to break and the desired effects will be reduced or eliminate.

This innovation is targeted to the control and reduction of diseases carried by insects, mainly to vulnerable populations, as this additive is low cost, and compatible with 90% of paint formulas, regardless of the price or brand.

The invention also provides the use of the active ingredient enhancer additive formulation for insecticide paint and paint obtained, for its incorporation into coatings, paint, traditional insecticides, adhesives, binders, and other vehicles to repel, reduce and control insects.

The formulation, according to this invention; counts on several competitive and differentiating advantages from the technical and procedural point of view, and also from a practical point of view, as such formulation counts on a better performance to control insects, due to its useful life of over 24 months.

Finally, from the financial point of view; the formulation is cheaper, in comparison to existing products, and also, it can be used on any surface, in an illustrative, not limitative way, we can mention the following: substrates such as textiles, paper, plastic, wood, metal; stones, concrete, gypsum, and any construction and interior design elements. Social benefits are wide, as our invention will become a big player in the control of plagues and diseases carried by insects.

The insect paint with the greatest efficiency was formulated in order to substantially improve, active ingredients/insecticides keeping a low content of these ingredients, but making them more effective, determining that if a catalyzing/triggering, element is added, which acts at a molecular level in their composition, these active ingredients were enhanced more than 4 times than the initial formula, and this offers quite a competitive advantage and a value added, which is offered by a unique controlled dosing system, delivering at several intervals, leading to outstanding results.

Several initial mixes of each pure insecticide with piperonyl butoxide (PBO) and microencapulated agents determined that it is a perfect mixing medium and it can be used as a basis for them to interact; thus, the microcapsule is the medium where they specifically interact, without scattering with other elements; thus, concentrating active ingredients directly, performing a total catalyzing.

The invention has been described enough for a person with medium knowledge on the field to reproduce and obtain the results mentioned in the invention herein. Nevertheless, any person with skills in the technical field related to this invention is able to make adjustments that have not been described in the request herein. Nevertheless, if the application of these adjustments on a certain structure or the manufacturing process thereof; the matters stated in the following claims are required, such structures must be included within the scope of the invention.

Having described the invention enough, I consider it an innovation and; thus, I claim the contents of the following claims my exclusive property:

1. An active ingredient enhancer formulation of insect paint characterized by containing at least one microencapsulated active ingredient (insecticide) selected from Cypermethrin, Deltamethrin or a mix thereof, including Piperonyl Butoxide (PBO) as catalyzing agent of such active ingredient (insecticide).

2. The active ingredient enhancer additive formulation for insecticide paint according to claim 1, characterized by also including Nonyl Phenol 10 as emulsion stabilizer, bringing fluidity to the reaction.
The active ingredient enhancer additive formulation for insecticide paint according to claim 1, characterized by the microcapsule forming compositions containing mineral oil, cypermethrin or deltamethrin, or a mix thereof, as the active ingredient (insecticide), Propylene Glycol, Piperonyl Butoxide, as catalyzing agent for the active ingredient: Nonyl Phenol 10, Melamine, Chitosan, Acetic acid, Glutaraldehyde, Sodium hydroxide and Calcium chloride.

4. The active ingredient enhancer additive formulation for insecticide paint according to anyone of the previous claims, characterized by such microcapsules being obtained through a polymeric microencapsulation process, a microencapsulation process by coacervation or through a microencapsulation process by ionic gelation.

5. The active ingredient enhancer additive formulation for insecticide paint according to claims 1 to 4, characterized by such active ingredient being microencapsulated in three microcapsules, some microcapsules with cypermethrin, other microcapsules with deltamethrin and other microcapsules with a mix of cypermethrin and deltamethrin.

6. A water-based vinyl paint characterized by including an active ingredient enhancing formulation that contains at, least one microencapsulated active ingredient (insecticide); including Piperonyl Butoxide (PBO) as catalyzing agent for such active ingredient (insecticide).

7. The water-based vinyl insecticide paint, according to claim 6, characterized by such active ingredient enhancing formulation for insecticide paint containing 6.10-26.50 g of Additive to add to the finished paint from 2.0 to 5 g of boric acid, from 0.10 to 0.50 g of microencapsulated deltamethrin, from 2.0 to 5.0 g of microencapsulated cypermethrin, from 1.0 to 6.0 g of calcium carbonate and 2.0 to 10.0 g of microsilica.

8. The water-based vinyl insecticide paint, according to claim 7, characterized by containing 15 g of the formulation per liter of water-based vinyl paint.

9. A manufacturing process of an active ingredient enhancing formulation for insecticide paint defined by at least one microencapsulated active ingredient (insecticide), including Piperonyl Butoxide (PBO) as catalyzing agent for such active ingredient (insecticide),
a) Microencapsulating insecticide active ingredients through polymeric microencapsulation, coacervation or ionic gelation microencapsulation;
b) Incorporating microencapsulated insecticides and microsilica into a food grade stainless steel metallic recipient for 25 to 30 minutes at a maximum speed of 400 rpm, otherwise, the microcapsules could break. Also, only these three elements must be added first so the microsilica holes are filled with insecticide active ingredients, attaining extended duration of such active ingredients;
c) Incorporating the mix to boric acid, carefully, as the mix from the previous step is quite volatile and it may be toxic if inhaled, The use of safety gear is recommended at all times. Mix again at a speed of 400 rpm, for another 20 minutes, at least, to reach optimal results.
d) Add calcium carbonate, only to provide consistency to the formula. Nevertheless, calcium carbonate of the highest quality possible must be used, otherwise, it will not incorporate easily, even the color of the final product may be poor. The mix must be stirred at less than 400 rpm for 20 additional minutes.
